(19) United States
(12) Patent Application Publication
(10) Pub. No.: US 2004/0197590 A1
(43) Pub. Date: Oct. 7, 2004

(54) Method for obtaining a synthetic leather suitable in particular for lining instrument panels in motor vehicles and leather thus obtained

(76) Inventors: Paolo Cittadini, Luvinate (IT); Marco De Giorgi, Varese (IT)

Correspondence Address: Abelman Frayne & Schwab, 150 East 42nd Street, New York, NY, 10017-5612, US

(21) Appl. No.: 10/474,891

(22) PCT Filed: Mar. 5, 2002
(86) PCT No.: PCT/EP02/02442

(30) Foreign Application Priority Data
Apr. 13, 2001 (IT) MI2001A000808

(51) Int. Cl. B32B 27/32; B32B 27/06

(52) U.S. Cl. 428/516; 428/515; 428/523; 428/904

(57) ABSTRACT

The present invention relates to a synthetic leather free from halogens and prepared with a method characterized in that it comprises the following stages: a) forming, in a mould by means of slush moulding, a first layer, i.e. the visible layer in the finished leather, from a polyolefin composition grafted with silanes and cross-linkable in the presence of water, b) in immediate succession, forming, in said mould by means of slush moulding, a second layer from a polyolefin composition having a semi-crystalline phase with a high melting point not less than 120° C. and preferably not less than 140° C.

It is common to use known techniques such as slush moulding for the production of synthetic leathers suitable for lining the internal furnishings of motor vehicles, in particular the instrument panels. With this technique it is possible to obtain, already in the final form and without frozen internal stresses, synthetic leathers which have a pronounced convex shape and also a fairly complex geometry. Moreover, with slush moulding it is possible to impart to the leather, with a high degree of precision, any surface design provided on the mould.

The present Applicant is the proprietor of patents relating to particular techniques for the slush moulding of thermoplastic, thermosetting and elastomer resins in powder formed intended to produce these linings in imitation leather for car dashboards, such as for example the European patents 0,476,742 and 0,821,643.

In order to produce this type of synthetic leather hitherto in particular PVC (polyvinylchloride) has been used.

A very common problem in the sector nowadays is that of obtaining leathers by means of slush moulding technology using materials other than PVC (so-called PVC-free materials) in order to avoid the environmental and recycling problems arising from the use of a chlorinated plastic, which practice is gradually being abandoned.

The advantage of using PVC in slush moulding consists in its low viscosity during gelling, which allows optimum dispersion (spreadability) over the mould and a precise reproduction of the design in the mould itself. As regards the mechanical properties, PVC satisfies the specifications of the motor car industry: owing to its high molecular weight it has in particular a high ageing resistance at high temperatures. The low viscosity which is typical of PVC in the melted state due to the presence of plasticizers, in the case of other halogen-free plastics which cannot be plasticized with liquids, however, is not associable with a high molecular weight (which provides good mechanical and ageing resistance properties). High molecular weights in PVC-free materials generally result in a high viscosity of the material in the melted state, which prevents spreading of the material over the mould without causing shearing stresses, and therefore frozen internal stresses, this fact being one of the main advantages of slush moulding compared to vacuum forming or injection moulding.

Owing to the high cost, for example the use of liquid polyurethanes sprayed onto a mould and thermoplastic polyurethanes in powder form in place of PVC has proved to be unsatisfactory, also because polyurethanes produce toxic decomposition products and are therefore difficult to recycle or dispose of.

More suitable materials for replacement of PVC from both an ecological and economic point of view nowadays appear to be polyolefin thermoplastic materials which, however, have a low softening point and a limited resistance to ageing, to solvents, to abrasion and to scratching.

The patent application WO97/36958 describes a cross-linkable grafted polyolefin thermoplastic composition in powder form for producing soft linings by means of slush moulding or rotational moulding. With the cross-linkable grafted polyolefin composition proposed therein it is attempted to obtain the main characteristics prescribed by car manufacturer specifications, such as resistance to heat, solar radiation and abrasion.

Various methods which are used for obtaining a cross-linked synthetic leather from polyolefin compositions are known. For example, Italian patent MI 99 A000379 in the name of the same Applicant describes a method for slush moulding polyolefin resins which is characterized by a cross-linking step which uses radiation, preferably beta radiation. The cross-linking is performed in order to improve the mechanical properties, in particular the abrasion resistance and surface ageing resistance. Cross-linking, also obtained using radiation, is furthermore described in JP 01275640, JP 59197161 and JP 51092855.

Cross-linking, which is indispensable on the one hand in order to impart satisfactory mechanical properties to the leathers obtained from these PVC-free materials, on the other hand, however, gives rise to a serious technical problem. Returning, for example, to the already mentioned document WO97/36958, it envisages for cross-linking a silane as grafting agent, a hydrolysis catalyst, such as a derivative of tin, and the presence of water. Cross-linking furthermore proceeds more rapidly the higher the temperature. In accordance with this prior art, the cross-linking of slush-moulded leather may be performed at at least 50° C. in the presence of water vapour and in the examples a cross-linking temperature with vapour at 60° C. for an indefinite period of time is indicated. Alternatively, cross-linking is accelerated by the presence, in the vapour at 60° C., of the hydrolysis catalyst consisting of a compound of tin which, however, owing to its toxicity, results in environmental problems.

The cross-linking reaction may be performed while the leather is still in the mould which, however, thus remains occupied for a time such that the process becomes uneconomical. If it is attempted, as is desirable, to perform this cross-linking operation outside of the slush-moulding mould, obviously in order to free the mould so as to increase the productivity, it is necessary to extract the leather from it in a state which is not yet cross-linked and therefore easily deformable since it does not have sufficient thermal resistance and mechanical strength. This constitutes a first aspect of the problem.

The low thermal resistance of the leather soon after formation and extraction from the mould constitutes a drawback also with respect to the choice of the most efficient cross-linking conditions.

In fact, at the temperatures suitable for rapid cross-linking in presence of water (≧85° C.), the leather is easily subject to permanent deformations caused, for example, by its own weight. Lower temperatures require longer cross-linking times and this complicates the practical implementation of the industrial process.

For the solution of this technical problem and in order to obtain other advantages which will emerge from the remainder of the present description, the invention proposes a method for obtaining a synthetic leather which is formed by at least two different halogen-free polyolefin materials and can be used in particular as a lining for internal parts of a motor vehicle, such as instrument panels, characterized in that it comprises the following stages:

a) forming, in a mould by means of slush moulding, a first layer, i.e. the visible layer in the finished leather, which is formed by a polyolefin composition grafted with silanes and cross-linkable in the presence of water;

b) in immediate succession, forming, in said mould by means of slush moulding, a second layer from a polyolefin composition having a semi-crystalline phase with a high melting point not less than 120° C. and preferably not less than 140° C.

The invention also relates to a synthetic leather which is free from halogens such as PVC and is suitable in particular as a lining for internal parts of a motor vehicle, such as dashboards and instrument panels, characterized in that it comprises a first layer, i.e. the visible layer in the finished leather, which is formed by slush moulding from a polyolefin composition grafted with silanes and cross-linked, and a second layer formed by slush-moulding from a polyolefin composition having a semi-crystalline phase with a high melting point not less than 120° C., preferably not less than 140° C.

Returning to the said method according to the invention, subsequently, once gelling and cooling of the said layers has been completed, it is envisaged performing stage c), i.e. extracting the leather thus formed from said mould in order to perform cross-linking of said first layer, to which are thus imparted all the chemical, thermal and mechanical properties necessary for satisfying the specifications required by the motor car industry. The mould, freed of the leather, may thus be used again immediately for production purposes.

According to the invention, the second layer formed by means of superimposition on the first layer imparts to the leather adequate thermal resistance and mechanical strength properties also in the absence of cross-linking, so as to allow its immediate removal from the slush-moulding mould and storage of the leather thus formed in devices suitable for completion of cross-linking in the desired conditions—for example at a high temperature—of the visible polyolefin layer, preventing permanent deformations from occurring in the leather itself.

Said cross-linkable polyolefin composition for forming said first layer according to said stage a) comprises an ethylene copolymer and a silane-containing grafting agent, whereby said copolymer may be present on its own or in a mixture with a polymer.

Said copolymer is preferably ethylene alkylene C₄-C₁₂, for example ethylene octene. Said polymer is polyethylene, preferably with a low density, such as LDPE or LLDPE.

Said composition may also comprise one or more thermoplastic elastomers, optionally with prevulcanized phases, chosen from among the copolymers: styrene-butadiene-styrene (SBS); styrene-isoprene-styrene (SIS); styrene-ethylene-butylene-styrene (SEBS); styrene-ethylene-propylene-styrene (SEPS); ethylene-propylene rubbers (EPR) and ethylene-propylene-diene monomer (EPDM), also partially or completely cross-linked; ethylene vinyl acetate (EVA) copolymers; ethylene copolymers and acrylic and methacrylic monomers in which the acid function may be salified with metals such as sodium, potassium, calcium, zinc and magnesium or esterified with aliphatic alcohols C₁-C₄.

Said polyolefin composition according to said stage b) comprises a polyolefin resin, such as polypropylene, a propylene-ethylene or propylene-butene copolymer and one or more thermoplastic elastomers, optionally with prevulcanized phases, chosen from among the copolymers: styrene-butadiene-styrene (SBS); styrene-isoprene-styrene (SIS); styrene-ethylene-butylene-styrene (SEBS); styrene-ethylene-propylene-styrene (SEPS); ethylene-propylene rubbers (EPR) and ethylene-propylene-diene monomer (EPDM), also partially or completely cross-linked; ethylene vinyl acetate (EVA) copolymers; ethylene copolymers and acrylic and methacrylic monomers in which the acid function may be salified with metals such as sodium, potassium, calcium, zinc and magnesium or esterified with aliphatic alcohols C₁-C₄.

In this case, said polyolefin elastomer which is included in the said composition for said stage b) may optionally include a process oil—for example paraffin oil—which helps reduce the viscosity in the melted state and the hardness, improving the flexibility characteristics.

In one mode of implementation according to the present invention, said polyolefin composition according to said stage b) also comprises blowing agents able to cause expansion of said second layer during slush moulding, such as, for example, azodicarbonamide, sodium bicarbonate or citric acid.

In a different mode of implementation according to the present invention, the method also comprises a stage of forming a further separate layer from an expandable composition by means of slush moulding following said second layer of said stage b), which in this case is not expanded. Said expandable layer is chosen from among any suitable mixture of materials compatible with those of said second layer, without particular restrictions, and formulated with blowing agents such as those mentioned just further above.

In order to understand better characteristics and advantages of the invention, examples of practical implementation, not to be regarded as limiting in any way, are indicated below.

### EXAMPLE 1

### Preparation of the Material for the First Layer (Stage a) of the Method, Component A

The copolymer ethylene octene ENGAGE 8400 produced by DuPont Dow Elastomers was grafted with silanes according to the prior art by means of reactive extrusion with 1.9 phr of vinyl trimethyoxysilane and 0.1 phr of dicumyl peroxide.

2.5 phr of carbon black and 0.6 phr of calcium stearate were also added to the mixture.

The granules thus obtained were then frozen-ground and the powder was sifted in order to eliminate the fraction with dimensions greater than 500 microns.

The MFI (ASTM D 1238) of the cross-linkable grafted composition obtained, measured at 190°/2, 16 kg was equal to 20 g/10′ and the maximum melting point (DSC; ASTM D 3418) equal to 85° C.

### Preparation of the hydrolysis catalyst

1.5 parts of dibutyl tin dilaurate were added to 100 parts of LLDPE in powder form with an average diameter of 17 microns (Coathylene Special Fine Powders produced by DuPont) and homogenised in a high-speed mixer.

### Preparation of the Material for the Second Layer (Stage b) of the Method, Component B

Espolex K52 produced by Sumitomo Chemical was used, this product consisting of a powder with a polyolefin composition suitable for the production of synthetic leathers using the technique of slush moulding, but characterized by a low abrasion resistance such that it requires surface lacquering. This composition is characterized by the presence of a rubbery phase and a polypropylene semi-crystalline phase and also by:

MFI (ASTM D 1238): 28 g/10′

maximum melting point (DSC; ASTM D3418): 150° C.

average diameter: 225 microns

dry abrasion resistance (Crockmeter DIN 54 2002): 3

### Preparation of the Leather by Means of Double Slush

Shortly before preparation of the leather, 5 parts of the predispersed hydrolysis catalyst are mixed homogeneously with the component A for formation of the first layer.

Said first layer is obtained by means of a first slush-moulding operation. Said slush-moulding operation is immediately followed by a second operation using the said component B.

The nickel mould used, preheated in an air furnace, has a suitably prepared surface and has undercuts which make the test particularly critical, highlighting the good flow characteristics of the powder.

After rapid cooling in water, the composite leather was extracted from the mould and it was possible to verify its homogenous nature and the absence of obvious porosity.

Then it was placed for two hours in a moisture-saturated environment at a temperature of 90° C., suitable for rapid cross-linking in accordance with said stage c), at the same time as a series of butterfly test-pieces previously obtained from the composite leather and subjected to a tensile stress in order to verify their temperature resistance.

At the end of the rapid cross-linking treatment, the composite leather assumed characteristics which meet the specifications of car manufacturers without undergoing deformations as demonstrated by the absence of deformations in the control test-pieces which simulate the situation where large-size leathers, hung, are subject to stress (see table below).

### EXAMPLE 2

A composite cross-linkable leather with a second expanded layer was produced, using the same procedures as in Example 1, except for the composition of the second layer which in this case was produced with a powder obtained by mixing in a high-speed mixer 99 parts of the said component B according to example 1 with 1 part of azodicarbonamide.

By controlling the expansion time after carrying out the second slush-moulding operation it is possible to determine the thickness of the layer formed.

After rapid cooling in water, the composite leather was extracted and it was possible to verify its homogenous nature, the absence of obvious surface porosity and the constant and regular thickness of the second expanded layer.

Then it was placed for two hours in a moisture-saturated environment at a temperature of 90° C., suitable for rapid cross-linking, at the same time as a series of butterfly test-pieces previously obtained from the composite leather and subjected to a tensile stress in order to verify their temperature resistance (see table below).

At the end of the rapid cross-linking treatment, the composite leather assumed characteristics which meet the requirements of car manufacturers without undergoing deformations as demonstrated by the absence of deformations in the control test-pieces.

### COMPARATIVE EXAMPLE

A cross-linkable leather with a single layer was produced using the component A of the said example 1, thus being devoid of the second layer.

After formation of the leather by means of a single slush-moulding operation and rapid cooling in water, the leather was extracted and it was possible to verify its homogenous nature and lack of obvious porosity.

Then it was placed in a moisture-saturated environment at a temperature of 90° C., suitable for rapid cross-linking, at the same time as a series of butterfly test-pieces previously obtained from the composite leather and subjected to a tensile stress in order to verify their temperature resistance (see table below).

The test-pieces, in this case, underwent rapid deformation until breakage occurred after 8 minutes.

Heat Deformability (Hot Set Value)

For the various leathers obtained in accordance with the above examples, in addition to the mechanical properties, a heat resistance parameter (hot set value) was measured, using the following test method, where it is intended to simulate the situation in which large-size leathers, hung, are subject to stress.

For this purpose, a butterfly test-piece for tensile tests in accordance with ASTM D 412 is positioned by means of a suitable support within the cross-linking environment at the same time as the leather and is subjected to a tensile stress of 0.1 MPa.

As an indication of the greater or lesser heat resistance of the leather, the permanent deformation over time of the test-piece was recorded.

The results obtained are shown in the following summary table:

TABLE

| | | | Comparative |
|---|---|---|---|
| | Example 1 | Example 2 | example |
| Heat resistance: | No variation | No variation | Breakage of test- |
| 90° C./0.1 MPa | within 60′ | within 60′ | piece within 8′ |

As can be seen from the data shown above, whereas the single-layer leather of the comparative example has no heat resistance, as demonstrated by the breakage of the test-pieces, the leather formed using the method according to the invention does not have deformations even after one hour of rapid cross-linking treatment at 90° C.

The technical problem described further above is therefore solved in an effective manner.

1. Method for obtaining a synthetic leather which is free from halogens such as PVC and suitable in particular as a lining for internal parts of a motor vehicle, such as dashboards and instrument panels,
characterized in that it comprises the following stages:
a) forming, in a mould by means of slush moulding, a first layer, i.e. the visible layer in the finished leather, from a polyolefin composition grafted with silanes and cross-linkable in the presence of water;
b) in immediate succession, forming, in said mould by means of slush moulding, a second layer from a polyolefin composition having a semi-crystalline phase with a high melting point not less than 120° C. and preferably not less than 140° C.

2. Method according to claim 1, characterized in that it comprises, after said stage b), a stage c) of extracting the leather thus formed from the mould in order to perform cross-linking of said first layer.

3. Method according to claim 1, characterized in that said cross-linkable polyolefin composition for forming said first layer according to said stage a) comprises an ethylene copolymer.

4. Method according to claim 3, characterized in that said composition comprises a polymer.

5. Method according to claim 3, wherein said composition comprises an elastomer.

6. Method according to claim 4, characterized in that said polymer is polyethylene.

7. Method according to claim 3, characterized in that said copolymer is ethylene-alkylene C₄-C₁₂.

8. Method according to claim 7, characterized in that said copolymer is ethylene-octene.

9. Method according to claim 5, characterized in that said elastomer is chosen from among the copolymers; styrene-butadiene-styrene (SBS); styrene-isoprene-styrene (SIS); styrene-ethylene-butylene-styrene (SEBS); styrene-ethylene-propylene-styrene (SEPS); ethylene-propylene rubbers (EPR) and ethylene-propylene-diene monomer (EPDM), also partially or completely cross-linked; ethylene vinyl acetate (EVA) copolymers; ethylene copolymers and acrylic and methacrylic monomers in which the acid function may be salified with metals such as sodium, potassium, calcium, zinc and magnesium or esterified with aliphatic alcohols C₁-C₄.

10. Method according to claim 1, characterized in that said polyolefin composition according to said stage b) comprises a polyolefin resin, chosen from polypropylene or its copolymers, such as propylene-ethylene or propylene-butene.

11. Method according to claim 10, characterized in that said composition comprises one or more thermoplastic elastomers chosen from among the following copolymers: styrene-butadiene-styrene (SBS); styrene-isoprene-styrene (SIS); styrene-ethylene-butylene-styrene (SEBS); styrene-ethylene-propylene-styrene (SEPS); ethylene-propylene rubbers (EPR) and ethylene-propylene-diene monomer (EPDM), also partially or completely cross-linked; ethylene vinyl acetate (EVA) copolymers; ethylene copolymers and acrylic and methacrylic monomers in which the acid function may be salified with metals such as sodium, potassium, calcium, zinc and magnesium or esterified with aliphatic alcohols C₁-C₄.

12. Method according to claim 5, wherein said elastomer comprises prevulcanized phases.

13. Method according to claim 11, characterized in that said composition comprises a process paraffin oil.

14. Method according to claim 1, characterized in that said polyolefin composition according to stage b) also comprises blowing agents able to cause expansion of said second layer during slush moulding, such as, for example, azodicarbonamide, sodium bicarbonate or citric acid.

15. Method according to claim 1, characterized in that it comprises, subsequent to formation of said second layer layer according to said stage b), a further stage of forming, by means of slush moulding, a further layer from an expandable composition, thereby forming an expanded layer separate from said second layer.

16. Synthetic leather which is free from halogens such as PVC and suitable in particular as a lining for internal parts of a motor vehicle, such as dashboards and instrument panels, characterized in that it comprises a first layer, i.e., the visible layer in the finished leather, formed by means of a slush moulding from a polyolefin composition grafted with silanes and cross-linked and a second layer superimposed on said first layer and formed by means of sluch moulding from a polyolefin composition having a semi-crystalline phase with a high melting point not less than 120° C. and preferably not less than 140° C.

17. Synthetic leather produced with the method according to claim 1.

18. Synthetic leather produced with the method according to claim 2.

19. The method according to claim 4, wherein said composition comprises an elastomer.

20. The method according to claim 11, wherein said elastomer comprises prevulcanized phases.
